(19) United States
(12) Patent Application Publication
(10) Pub. No.: US 2017/0318082 A1
(43) Pub. Date: Nov. 2, 2017

(54) METHOD AND SYSTEM FOR PROVIDING EFFICIENT RECEIVE NETWORK TRAFFIC DISTRIBUTION THAT BALANCES THE LOAD IN MULTI-CORE PROCESSOR SYSTEMS

(71) Applicant: QUALCOMM INCORPORATED, SAN DIEGO, CA (US)

(72) Inventors: BHUPINDER THAKUR, Bangalore (IN); VENKATESHWARLU VANGALA, Bangalore (IN); DEEPAK KUMAR KALLEPALLI, Bangalore (IN)

(21) Appl. No.: 15/237,650

(22) Filed: Aug. 16, 2016

(30) Foreign Application Priority Data
Apr. 29, 2016 (IN) 201641014970

(51) Int. Cl. H04L 29/08; H04L 12/801; H04L 12/851; H04L 12/761; H04W 88/02

(52) U.S. Cl. CPC H04L 67/1002; H04L 47/2441; H04L 45/16; H04L 47/196; H04W 88/02

(57) ABSTRACT

Systems and methods for improved received network traffic distribution in a multi-core computing device are presented. A hardware classification engine of the computing device receives a data packet comprising a portion of a received network traffic data flow. Packet information from the data packet is identified. Based in part on the packet information, the classification engine determines whether a core of a multi-core processor subsystem is assigned to the data flow of which the packet is a part. In embodiments, this determination may be made based on one or more criteria, such as a work load of the core(s) of the processor subsystem, a priority level of the data flow, etc. Responsive to the determination that a core is not assigned to the data flow, a core of the multi-core processor is assigned to the data flow and the data packet is sent to the first core for processing.

### PRIORITY AND RELATED APPLICATIONS STATEMENT

This application claims priority under 35 U.S.C. §119(a)-(d) to Indian Application Serial No. 201641014970, filed on Apr. 29, 2016, entitled, “METHOD AND SYSTEM FOR PROVIDING EFFICIENT RECEIVE NETWORK TRAFFIC DISTRIBUTION THAT BALANCES THE LOAD IN MULTI-CORE PROCESSOR SYSTEMS,” the entire contents of which are hereby incorporated by reference.

### DESCRIPTION OF THE RELATED ART

Computing devices, such as gateway devices can deliver network speeds up to gigabit traffic to a location such as a home. These devices typically handle different functions such as receiving network traffic packets, access control list (ACL) filtering, packet classification and modification, and transmitting modified packets. The packets which are meant for processing, such as packets that are part of network data flows for a Network Attached Storage (NAS) device attached to the gateway or file-transfer-protocol (FTP) traffic are classified and forwarded to a processing system after the classification.

The processing system may comprise multiple central processing unit (CPU) cores that typically run Symmetric multiprocessing (SMP) operating systems. The processing system may also have a network stack for processing network traffic, which is usually SMP aware. Network traffic is typically scheduled on different CPU cores based on which CPU core receives received data (Rx) interrupts. If one CPU core receives more Rx interrupts compared to the other CPU core, that CPU core is loaded with more work than the other cores. This leads to inefficient use of the multiple CPU cores.

Existing mechanisms to solve the above problem are not efficient. Typical systems allow packets received at one CPU core to be scheduled for processing on a different CPU core. However, such systems require Rx interrupt handling for the received packets on the CPU core that received the interrupt. Under heavy load, the core handling the Rx interrupts may be overloaded and become a bottleneck while other cores still have bandwidth to process more packets. A second problem is that there is overhead for each packet to determine on which CPU core the packet should be scheduled and then raising an intra CPU core interrupt to trigger the other core to process the scheduled packets. A third problem is that these systems do not support user-defined criteria for routing received packets, such as if a user desires to process priority network traffic on a specific CPU.

Thus, what is needed in the art are methods and systems for providing efficient network traffic distribution that addresses the above problems and allows balancing CPU or processor work load across multiple cores in a computing device.

### SUMMARY OF THE DISCLOSURE

Systems and methods may distribute the received network traffic among available CPU cores based on user defined criteria that may comprise at least one of: an even distribution of the CPU load; prioritization of specific traffic by type, i.e. such as Voice data, multi cast data compared to internet data, etc., as required by the system irrespective of the interrupt load that is assigned to a particular CPU core. The network traffic may comprise multiple data flows, where each data flow maps to a single Transmission Control Protocol (TCP)/User Datagram Protocol (UDP) connection.

The system and method allow each packet flow to be mapped to a specific CPU core efficiently, so that all data packets belonging to a particular data flow will be processed by the specified core only—without the need to distribute received network data packets to target CPUs via intra core interrupts. The target CPU core may in some embodiments be derived by a feedback mechanism as a function of the current CPU load across multiple cores and/or priority of the flow to avoid congestion with other traffic on other cores.

In operation, an exemplary method for improved received network traffic distribution in a multi-core computing device comprises receiving with a hardware classification engine of the computing device a data packet, the data packet comprising a portion of a received network traffic data flow. Packet information from the data packet is identified. Based in part on the packet information, the classification engine determines whether a core of a multi-core processor subsystem is assigned to the data flow of which the packet is a part. Responsive to the determination that a core is not assigned to the data flow, a first core of the multi-core processor is assigned to the data flow, and the data packet is sent to the first core for processing.

Another example embodiment of improved receive network traffic distribution in a computing device is a computer system comprising a memory subsystem; a processor subsystem in communication with the memory subsystem, the processor subsystem comprising a plurality of cores; and a classification subsystem in communication with the memory subsystem and the processor subsystem. The classification subsystem includes a hardware classification engine configured to: receive a data packet comprising a portion of a received network traffic data flow; identify packet information from the data packet; determine, based in part on the packet information, whether any of the plurality of cores of the processor subsystem is assigned to the received data flow; responsive to the determination that none of the plurality of cores assigned to the data flow, assign a first core of the plurality of cores to the data flow; and send the data packet to the first core.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an example embodiment of a system including a computing device in which the improved receive network traffic distribution for multi-core processor systems may be implemented;

FIG. 2 is a functional block diagram illustrating an exemplary operation of aspects of the system of FIG. 1;

FIGS. 3A-3E are core utilization charts illustrating how a specific TCP or UDP data flow may be dynamically mapped to different CPU cores, such as those illustrated in FIG. 1 or FIG. 2;

FIGS. 4A-4B are core utilization charts illustrating exemplary improved efficiencies from the system of FIG. 1 or FIG. 2 and/or the methods of FIGS. 5A-5B;

FIG. 5A is a flowchart illustrating aspects of an exemplary method for improved receive network traffic distribution for multi-core processor systems;

FIG. 5B is a flowchart illustrating aspects of another exemplary method for improved receive network traffic distribution for multi-core processor systems; and

FIG. 6 is a functional block diagram of an exemplary computing device on which the system of FIG. 1, components of FIG. 2, and/or the methods of FIGS. 5A-5B may be implemented.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various non-transitory computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “computing device” is used to mean any device implementing a processor (whether analog or digital) in communication with a memory, such as networking hardware (including gateway devices), a desktop computer, server, or a gaming console. A “computing device” may also be a “portable computing device” (PCD), such as a laptop computer, handheld computer, tablet computer, smartphone, wearable computing device, etc.

The terms PCD, “communication device,” “wireless device,” “wireless telephone”, “wireless communication device,” and “wireless handset” are understood to be interchangeable herein. With the advent of third generation (“3G”) wireless technology, fourth generation (“4G”), Long-Term Evolution (LTE), etc., greater bandwidth availability has enabled more portable computing devices with a greater variety of wireless capabilities. Therefore, a portable computing device may also include a cellular telephone, a pager, a smartphone, a navigation device, a personal digital assistant (PDA), a portable gaming console, a wearable computer, or any portable computing device with a wireless connection or link.

In order to meet the ever-increasing processing demands placed on computing devices, including networking hardware such as gateways, these devices increasingly incorporate multiple processors or cores (such as central processing units or “CPUs”) running various threads in parallel. In the case of gateways, these multiple processors or cores may allow for parallel processing of network traffic received at the gateway (Rx network traffic). As will be understood, such network traffic may comprise multiple data flows comprised of data packets, where each data flow maps to a single Transmission Control Protocol (TCP)/User Datagram Protocol (UDP) connection. The data flows may include different types of data or data packets, i.e. such as Voice data, multi-cast data, internet data, etc. Moreover, one or more of these types of received data packets may require processing by the gateway device, such as packets that are part of data flows for a Network Attached Storage (NAS) device attached to the gateway device, data flows for file-transfer-protocol (FTP) traffic.

For such gateway devices network traffic is typically scheduled on different CPUs or cores of a multi-processor system based on which CPU receives more received data (Rx) interrupts. If one CPU receives more Rx interrupts compared to the other CPU, that CPU is loaded with more work than the other cores. This leads to inefficient use of the multiple CPUs. The system and methods of the present disclosure implement a classification subsystem, including a hardware classification engine at the network interface that references a data flow entry table to allow efficient distribution of each data flow to a specific CPU of the multi-CPU processor subsystem. Each data flow is mapped in the data flow entry table to a specific CPU, and all data packets belonging to a particular data flow are distributed to the specified CPU by the classification subsystem. In an embodiment the classification subsystem may distribute the data flows to a CPU-specific queues in a memory subsystem.

As a result, all data packets belonging to a particular data flow are processed only by the specified CPU, avoiding the need to receive the data packets on a first CPU and then distribute received network data packets to the target CPU(s) via intra CPU/core interrupts. In addition, to the overhead savings from avoiding unnecessary data packet processing and interrupt handling, the systems and methods of the present disclosure allow for user-defined criteria, policies, rules, etc. to be implemented when determining which CPU will be assigned a particular data flow. Such criteria, policies, or rules may include static considerations such as specifying certain CPU(s) for certain types of data flows for quality of service (QoS) considerations. Additionally, such criteria, policies, or rules may include dynamic considerations such as present workload levels on each CPU in order to ensure load balancing among the CPUs. Moreover, in some embodiments the criteria, policies. Or rules may allow for one or more data flows to be re-assigned from a first CPU to a different CPU as needed or desired for QoS, workload balancing, or other considerations.

Although discussed herein in relation to gateway networking devices, the systems and methods herein—and the considerable savings made possible by the systems and methods—are applicable to any computing device implementing multiple CPUs/cores that receive network traffic.

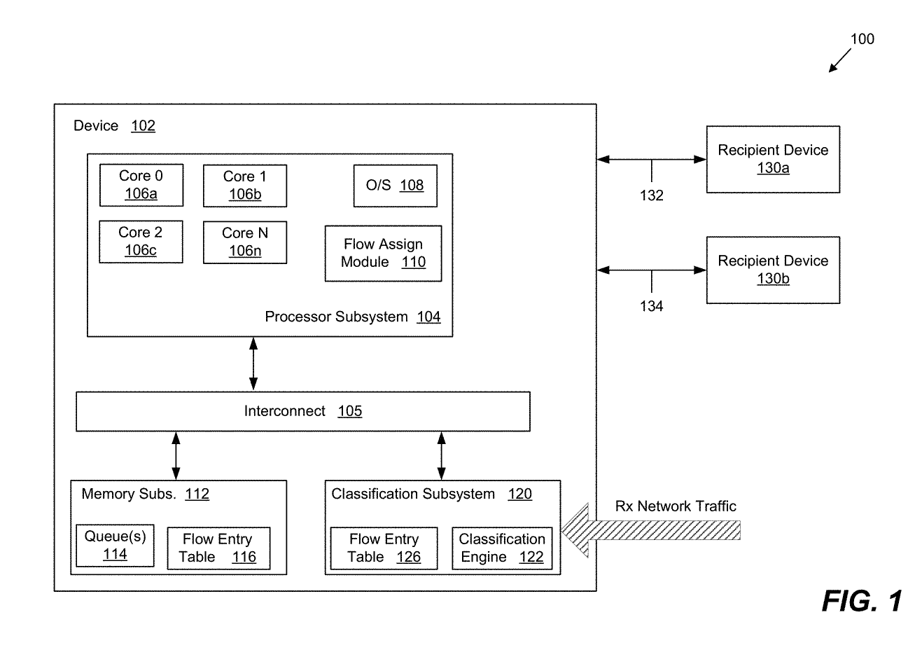

Referring initially to FIG. 1, this figure illustrates a block diagram of an exemplary system 100 including a computing device 102 in which the improved receive network traffic distribution for multi-core processor systems may be implemented. The computing device 102 may be any computing device which receives network traffic (illustrated with the arrow in FIG. 1), including a network gateway, such as for home use. The illustrated embodiment of the device 102 includes a processor subsystem 104, a memory subsystem, and a classification subsystem 120 electrically coupled to each other via a bus/interconnect 105. The interconnect 105 may be any desired type of bus or interconnect, including a memory bus or memory controller, a peripheral bus, and a local bus using any of a variety of bus architectures, which may depend on the architecture of the device 102.

The device 102 may also be in communication with one or more external recipient devices 130a and 130b via various communication lines 132, 134 as illustrated in FIG. 1. For example, in an embodiment where the device 102 is a gateway, the device 102 may be in communication with various other devices, such as for example a wireless phone 130b via a wireless communication link 134. In such an embodiment packets of a voice data flow received at the device 102 as part of Rx Network Traffic may be processed by the device 102 and routed to the wireless phone 130b via the wireless communication link 134.

At the same time, the device may receive other data flows as part of Rx Network Traffic and route the packets of one or more different data flows to different recipient devices (such as 130a) over various wired or wireless communication links (such as 132). For example, device 130a may comprise a Network Attached Storage (NAS) device 130a attached to the gateway device 102 of FIG. 1. Data flows intended for the device 102 may be received as part of the Rx Network Traffic, may be processed by the device 102 and routed to the NAS device 130a via a wired communication link 134 in an embodiment. As will be understood devices 130a and 130b may in some embodiments include other computing devices, such as laptop computers, desktop computers, tablet computers, gaming consoles, storage devices (e.g. USB, SATA), etc.

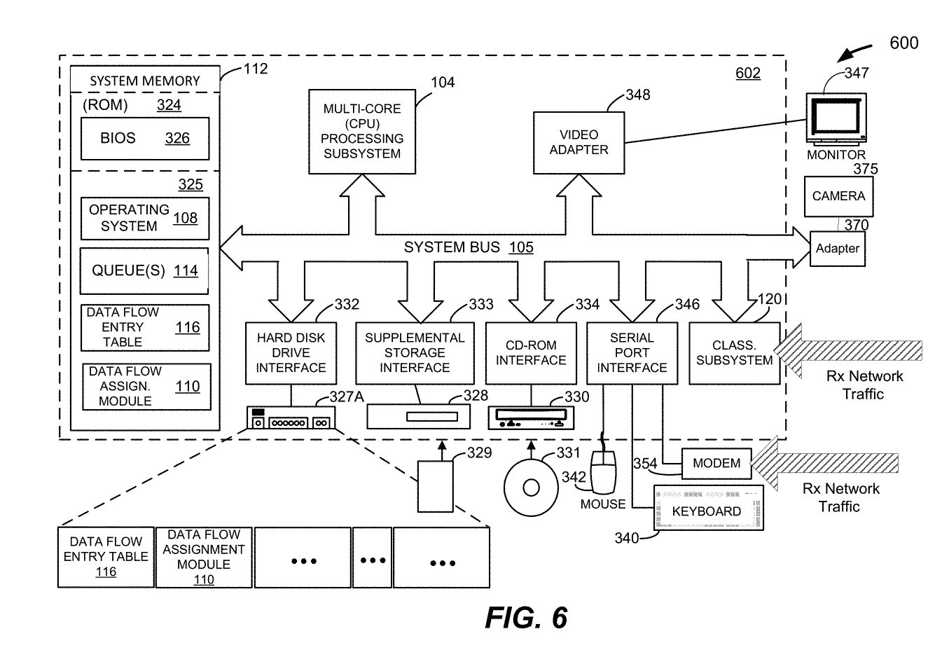

It will also be understood that the device 102 of FIG. 1, and the grouping of the components in FIG. 1, are for illustrative purposes. In various embodiments, device 102 may include additional components not illustrated in FIG. 1 (see for example FIG. 6) and/or may include components arranged differently than illustrated in FIG. 1.

The Processor Subsystem 104 includes multiple processors or cores, illustrated as a zeroth core (Core 0 106a), a first core (Core 1 106b), second core (Core 2 106c), and an Nth core (Core N 106n), where N is any desired integer. As understood by one of ordinary skill in the art different embodiments of the subsystem 104 may include more or fewer processors or cores (referred to as cores herein) than illustrated in FIG. 1. As also understood, one or more of the cores 106a-106n may comprise a central processing unit (“CPU”), a digital signal processor (“DSP”), a graphics processing unit (“GPU”), an analog processor, etc., in various embodiments. Each of the cores 106a-106n may have the same architectures, or one or more of cores 106a-106n may have different architectures, may process workloads at different efficiencies, may consume different amounts of power when operating, etc. Additionally, cores 106a-106n may also include drivers, hardware interfaces, cache(s), and/or other components to assist in executing tasks or threads.

The Processor Subsystem 104 of FIG. 1 also includes an operating system (O/S 108) which may be a common O/S 108 executed by each of cores 106a-106n. O/S 108 may be any desired operating system, including a high-level operating system (“HLOS”). Although illustrated as part of the Processor Subsystem 104 in FIG. 1 for illustrative purposes, the O/S 108 may in some embodiments be located in one or more memories of the Memory Subsystem 112. Alternatively, in other embodiments the Processor Subsystem 104 may include additional memories, not illustrated in FIG. 1, containing the O/S 108.

The Processor Subsystem 104 of FIG. 1 also includes a Data Flow Assignment Module 110. As discussed below the Data Flow Assignment Module 110 will in some embodiments make decisions about which of cores 106a-106n to assign to a particular data flow contained in the Rx Network Traffic received by the device. In some embodiments, such decisions may be based on one or more user-defined criteria, rules, or policies, including static and dynamic criteria, rules or policies. Additionally, the Data Flow Assignment Module 110 may communicate the decisions as to which core 106a-106n is assigned to a particular data flow to one or more of the Memory Subsystem 112 or the Classification Subsystem 120 of the device 102. In an embodiment, such communications may comprise writing the core assignment to one or more Data Flow Entry Table(s) 116, 126 located in the memory Subsystem 112 and Classification Subsystem 120, respectively. Although illustrated as one component in FIG. 1, the Data Flow Assignment Module 110, may in some embodiments be implemented as separate components, such as a separate data flow assignment portion/module and a data flow entry creation/update module.

The Processor Subsystem 104 is in communication with the Memory Subsystem 112 via Interconnect 105. In an embodiment, Memory Subsystem 112 may include one or more memory devices which may include one or more of static random access memory (SRAM), read only memory (ROM), dynamic random access memory (DRAM), or any other desired memory type, including a removable memory such as an SD card. As will be understood Memory Subsystem 112 of the device 102 may in some embodiment comprise multiple or distributed memory devices, one or more of which may be shared by various components of the device 102, such as cores 106a-106n. Additionally, as will be understood, one or more memory of the Memory Subsystem 112 may be partitioned if desired, such as to provide a portion of the memory dedicated to one or more components of the device 102, such as dedicated memory portions for each of cores 106a-106n.

In the embodiment of FIG. 1, Queues 114 are contained in one or more memory of the Memory Subsystem 112. As discussed below, in an embodiment the Queues 114 comprise a series of separate Queues 114 accessible by the Classification Subsystem 120, where each of the Queues 114 is also accessible by one of the cores 106a-106n. In this manner, packets for a data flow assigned to a particular one of the cores 106a-106n may be transferred to the target core (Core 0 106a for example) by placing the packets into the Queue 114 designated for Core 0 106a), as described below. Note that although illustrated in FIG. 1 as a single box, Queues 114 may comprise separate memories in some embodiments.

The Memory Subsystem 112 of the embodiment of FIG. 1 also includes a Data Flow Entry Table 116. As described below, during operation, which of cores 106a-106n is assigned to a particular data flow of the Rx Network Traffic received by the device 102 may be recorded or entered into a table, such as Data Flow Entry Table 116 in Memory Subsystem 112. The Data Flow Assignment Module 110 discussed above, or a portion thereof, may make such core assignment decisions and the Data Flow Assignment Module 110, or a portion thereof, may then cause an entry in the Data Flow Entry Table 116 associated with the data flow to be created or updated as desired. As additional data packets of the data flow arrive at the Classification Subsystem 120 as described below, the Classification Subsystem 120 may look up in the Data Flow Entry Table 116 which core 106a-106n is assigned to the data flow in order to cause the data packets to be routed to the assigned core.

The device 102 of FIG. 1 also includes a Classification Subsystem 120 in communication with the Interconnect 105. The Classification Subsystem 120 is responsible for ensuring that each packet of the various data flows are received for processing by the core 106a-106n assigned to each of the data flows. In an embodiment, the Classification Subsystem 120 includes a Classification Engine 122 configured to receive packets of Rx Network Traffic via one or more network interfaces (not illustrated). The Classification Engine 122 may be a hardware component in an embodiment, such as a hardware accelerator. As will be understood rather than one flow of Rx Network Traffic illustrated in FIG. 1, the Rx Network Traffic may comprise multiple separate data flows, including separate data flows received via different interfaces. Regardless of the number of interfaces, or how many separate data flows comprise the Rx Network Traffic, the packets comprising the data flows are received at the Classification Subsystem 120 and forwarded to the Classification Engine 122. The Classification Engine 122 then determines the assigned core 106a-106n for a particular data packet.

In an embodiment, the Classification Engine 122 may determine the assigned core 106a-106n for a particular data packet by identifying or receiving information about the data packet. The information about the data packet may identify a data flow of which the data packet is a part, such as 5-tuple information in some embodiments. In other embodiments, the information about the data packet may identify a type of data flow to which the packet belongs, such as Voice and Multicast data. Once the data flow is identified, the Classification Engine 122 may determine the core 106a-106n assigned to the data flow from information contained in one or more Data Flow Entry Tables 116, 126.

As illustrated in FIG. 1, in some embodiments the Classification Subsystem 120 may also include a software or firmware Data Flow Entry Table 126. The Data Flow Entry Table 126 is shown as a separate component of the Classification Subsystem 120 in FIG. 1 for illustrative purposes. In other implementations, the Data Flow Entry Table 126 may be a portion of the Classification Engine 122. As will be understood, making the Data Flow Entry Table 126 part of the Classification Engine 122, allows for faster look-ups by the Classification Engine 122, than may be possible with Data Flow Entry Table 116 located somewhere in the Memory Subsystem 112.

Similar to the Data Flow Entry Table 116 discussed above, the Data Flow Entry Table 126 in the Classification Subsystem 120 may contain information or mapping to provide an understanding of which core 106a-106n is assigned to a particular data flow, to a particular type of data flow, to a particular type of network traffic, etc. In an embodiment, the device 102 may implement the Data Flow Entry Table 126 of the Classification Subsystem 120 as the primary or first data table containing the core assignments for the first X number of data flows. In such embodiments, once a number of data flows greater than X are received by device 102, the information and/or core assignments for the subsequent X+1, X+2, etc., data flows are stored in Data Flow Entry Table 116 of the Memory Subsystem 112. The Data Flow Entry Table 116 may store as many additional data flows above the X data flows as allowed by the available memory capacity.

In other embodiments the Data Flow Entry Table 126 of the Classification Subsystem 120 may instead, or additionally, be used to store information about/core assignments for data flows deemed important or high priority according to some criteria. An example is an implementation where the Data Flow Entry Table 126 is part of the Classification Engine 122. In such implementations, the Data Flow Entry Table 126 may be used to store core assignments for data flows identified as comprising voice traffic, multi-media traffic, multi-cast traffic, and/or other high priority data flows according to a quality of service (QoS) consideration or criteria. Core assignment information for lower priority data flows may instead be stored in the Data Flow Entry Table 116 of the Memory Subsystem 112. As a result, in this implementation, the higher look-up speed of core assignments in the Data Flow Entry Table 126 located in the Classification Engine 122 is reserved for priority data flows.

Once the Classification Engine 122 determines the core 106a-106n assigned to a data flow associated with the packet, the Classification Engine 122 forwards the packet to the determined core 106a-106n. In an embodiment the Classification Engine 122 places the data packet(s) in the Queue 114 of the Memory Subsystem 112 that is coupled to the determined core 106a-106n.

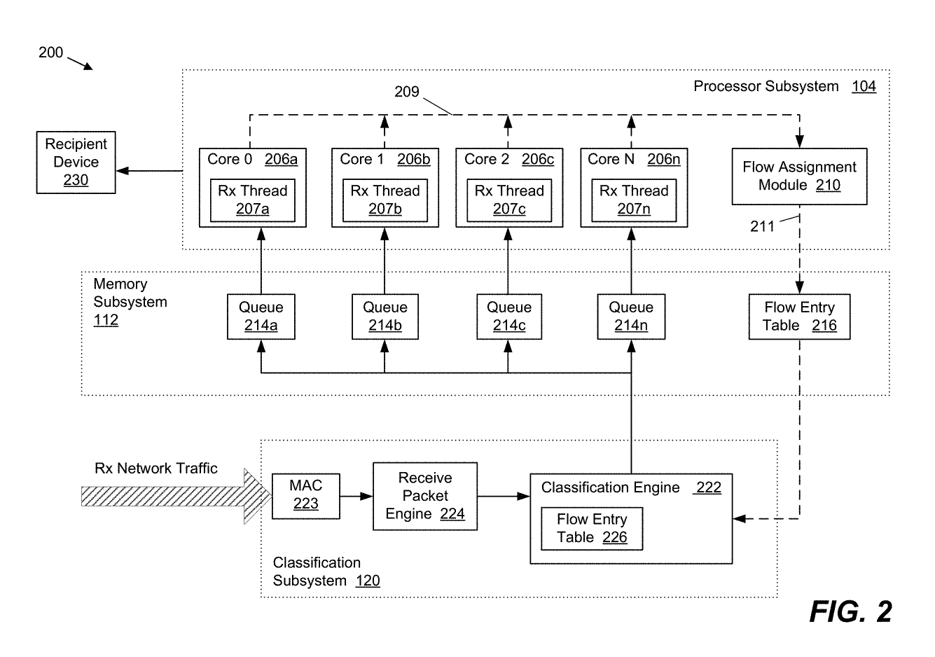

Turning to FIG. 2, a functional block diagram illustrates an exemplary operation of system 200 that includes additional aspects of system 100 of FIG. 1. System 200 of FIG. 2 includes multi-core Processor Subsystem 104, Memory Subsystem 112, and Classification Subsystem 120, which may comprise a computing device such as device 102 of FIG. 1. In an embodiment, the computing device may be a home gateway. The Processor Subsystem 104 is coupled to Recipient Device 130, which may be one or more of the Recipient Devices 130a-130b discussed above.

As shown in FIG. 2, the Processor Subsystem includes cores Core 0 206a, Core 1 206b, Core 2 206c, and Core N 206n (collectively referred to as cores 206a-206n). Each of cores 206a-206n is coupled to one of Queue 214a-Queue 214n of Memory Subsystem 112. Additionally, each of cores 206a-206n contains an Rx Thread 207a-207n, respectively. Rx Threads 207a-207n handle RX interrupts and/or obtaining data packets from the Queue 214a-214n coupled the respective core 206a-206n.

Processor Subsystem 104 also includes a Data Flow Assignment Module 210, illustrated as a single module or component in FIG. 2. Data Flow Assignment Module 210 receives or monitors control information 209 from each of cores 206a-206n. Control information 209 may include status information about the cores 206a-206n such as the work load of each of cores 206a-206n, what data flows are being handled by a particular core 206a-206n, or the amount/volume each core 206a-206n is handling. Based on this control information 209 and/or additional previously-defined criteria, rules, or policies, the Data Flow Assignment Module 210 may assign one of cores 206a-206n to a particular data flow of the Rx Network Traffic. The core/data flow assignment or mapping information is then written by Data Flow Assignment Module 210 to Data Flow Entry Table 216 of Memory Subsystem 112 (or Data Flow Entry Table 226 of Classification Engine 222). In an embodiment the assignment may be made by writing a flow entry in one of the Data Flow Entry Tables 216, 226 mapping or associating a number or identifier for the core with an identifier for the data flow.

The criteria, rules, or policies may in some embodiments include static considerations such as specifying certain CPU(s) for certain types of data flows for quality of service (QoS) considerations. For example, certain high priority data flows such as voice data flows or multicast data flows can be mapped to a single core, such as Core 1 206b, which is configured to process and/or is reserved for only these high priority data flows.

In an embodiment, Data Flow Assignment Module 210 (or other component of the system 200) may identify this type of high priority data flow and cause Core 1 to be assigned to the data flow by creating or updating a flow entry in Data Flow Entry Table 216 or 226 mapping Core 1 to the data flow. This may ensure excellent quality-of-service (QoS) for those high priority data flows as there will be a dedicated core available to process the data packets of these data flows. Correspondingly, a similar criteria, rule or policy may prevent Core 1, which is dedicated to high priority data flows in this example, from being assigned to other types of network traffic, regardless of any consideration of balancing the load among cores 206a-206n.

The criteria, rules, or policies may in some embodiments may additionally, or alternatively, include dynamic considerations such as present workload levels on each of cores 206a-206n. This information may be obtained via control information 209 provided by the cores 206a-206n or by monitoring the activity of the Rx Threads 207a-207n of each respective core 206a-206n. The present workload levels may be used in order to ensure load balancing among the cores 206a-206n. For example, in an embodiment, the Data Flow Assignment Module 210 may determine based on the control information 209 to assign new data flows to the core with the lowest workload level, and may accomplish such assignment by creating or updating a flow entry in Data Flow Entry Table 216 or 226 mapping Core 1 to the data flow.

In some embodiments, the dynamic considerations may allow one or more data flows to be reassigned from one core to a different core. For example, the Data Flow Assignment Module 210 may determine based on the control information 209 to move certain data flows from highly loaded core, such as Core 2 to one or more lightly loaded core, such as Core N. This reassignment may be accomplished by updating the corresponding flow entry in Data Flow Entry Table 216 or 226 with the new core number or identifier, in this example the core number or identifier for Core N.

The Data Flow Assignment Module 201 may be implemented in software, hardware, or both and may comprise multiple components rather than a single component/module as illustrated in FIG. 2. For example, in some embodiments the Data Flow Assignment Module 201 may be implemented as a data flow assignment portion or module for receiving the control information 209 and making determinations of core assignments; and a separate data flow entry creation/update portion or module for creating or updating the flow entries in the Data Flow Entry Tables 216, 226.

As illustrated in FIG. 2, during operation the Classification Subsystem 120 receives RX Network Traffic, which is illustrated as one data flow received at one network interface of the Classification Subsystem 120 for simplicity. It will be understood that the RX Network Traffic may comprise multiple separate data flows received at the same network interface, or additional network interfaces (not illustrated). In the embodiment of FIG. 2, the network interface includes a media access control (MAC) 223 that receives the data flows and a receive packet engine 224 for separating the packets of the data flows. In some embodiments the Classification Engine 222 may receive packets from more than one interface/MAC 223. Similarly, in some embodiments the Receive Packet Engine 224 may not be a separate component as illustrated in FIG. 2, but instead may be combined with or part of the MAC 223.

The data packets are then received by Classification Engine 222, which in the embodiment of FIG. 2, includes a Data Flow Entry Table 226. The Classification Engine 222 may identify or may receive (such as from Receive Packet Engine 224) information to understand which data flow the packet it is a part of. In an embodiment, such information may be 5-tuple information from the packet (source IP address, destination IP address, source port, destination port, and protocol). Once the data flow is identified, the Classification Engine 222 determines which of cores 206a-206n is assigned to the data flow, such as by looking up the flow entry for the data flow in Data Flow Entry Tables 226 or 216.

The Classification Engine 222 then places the packet in the Queue 214a-241n coupled to the core assigned to the data packet. The Rx Thread 207a-207n of the assigned core 206a-206n then causes the packet to be retrieved from the Queue 214a-214n and processed by the assigned core 206a-206n. Since the Rx Threads 207a-207n service only the packets arriving on the corresponding Queue 214a-214n and process the packets on that core 206a-206n only, any per packet overhead related to scheduling packets from one core to another core is avoided. Additionally, the parallel Queues 214a-214n and Rx Threads 207a-207n cause the different cores 206a-206n to process packets in parallel, achieving better throughput for multiple data flows received in the Rx Network Traffic.

As will be understood, additional static and/or dynamic criteria, policies, or rules other than those mentioned above may be used to assign cores 206a-206n to data flows as desired. Additionally, it will be understood that various criteria, policies, or rules may be ranked or prioritized as desired, such as for example to favor QoS over balancing workloads equally among the cores or vice versa. Similarly, it will be understood that some criteria, policies, or rules may be implemented by one component of the system 200 to assign cores to data flows, while other criteria, policies, or rules may be implemented by a different component of the system 200 to assign cores to data flows.

For example, in an embodiment, a static criteria, policies or rule, such as all data flows of a certain type be processed by a particular core, such as Core 1 206b may be implemented by Classification Engine 222. Classification Engine 222 may assign Core 1 206b to all voice data flows by creating a flow entry in Data Flow Entry Table 226 mapping Core 1 206b to any data flow identified as voice data flow. While a dynamic criteria, policy, or rule, such as assigning data flows to ensure load balancing among the cores may implemented by the Data Flow Assignment Module 210 in this embodiment. Data Flow Assignment Module 210 may assign to assign a second non-voice data flow to Core 2 206c by creating a flow entry in Data Flow Entry Table 216 of the memory Subsystem 112.

In other embodiments, multiple different components may act to implement a particular criteria, policy or rule. For example, Classification Engine 222 may randomly assign each new data flow to one of cores 206a-206n and create a flow entry for each new data flow in Data Flow Entry Table 226. Using 2 bits off of a hash of information for a received packet of a data flow, such as 5-tuple information, to assign a core to the data flow, gives a random assignment of data flows to cores 206a-206n, resulting in a relatively balanced workload among the cores. Data Flow Assignment Module 210 may then use control information 209 from the cores 206a-206n to ensure that the workload remains balanced. If one core has a lesser workload than the other cores, the Data Flow Assignment Module 210 can reassign one or more data flow to the core with the lesser workload by updating the flow entry for that data flow in Data Flow Entry Table 216 or 226.

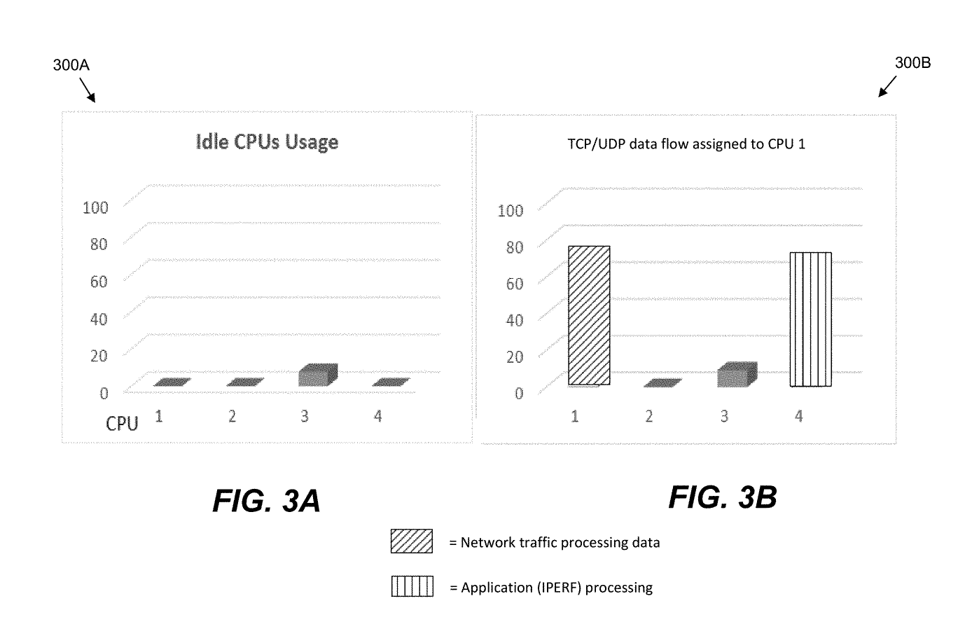

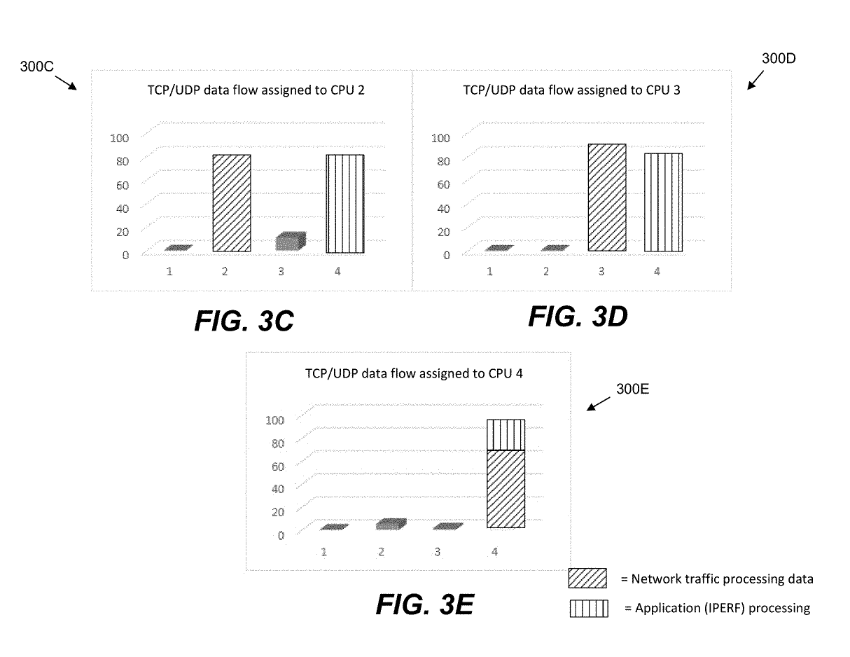

FIGS. 3A-3E are core utilization charts which illustrate how a specific TCP or UDP data flow may be dynamically mapped to different CPU cores, such as those illustrated in FIG. 1 (cores 106a-106n) or FIG. 2 (cores 206a-206n). Each plot (3A-3D) shows how a network traffic data flow (angled cross-hatched filled bars) may be moved/serviced by a different core. In FIG. 3A the cores are idled. In FIGS. 3B-3E, application processing (IPERF) for the device 102 is always assigned to, and executed by, Core 4.

As understood by one of ordinary skill in the art, IPERF is a commonly-used network testing tool that can create Transmission Control Protocol (TCP) and User Datagram Protocol (UDP) data streams and measure the throughput of a network that is carrying them. IPERF is a tool for network performance measurement usually written in the computer language C. As illustrated in FIGS. 3B-3E, the present system and methods are useful to directly control the assignment of data flows and/or number of data flows assigned to each core.

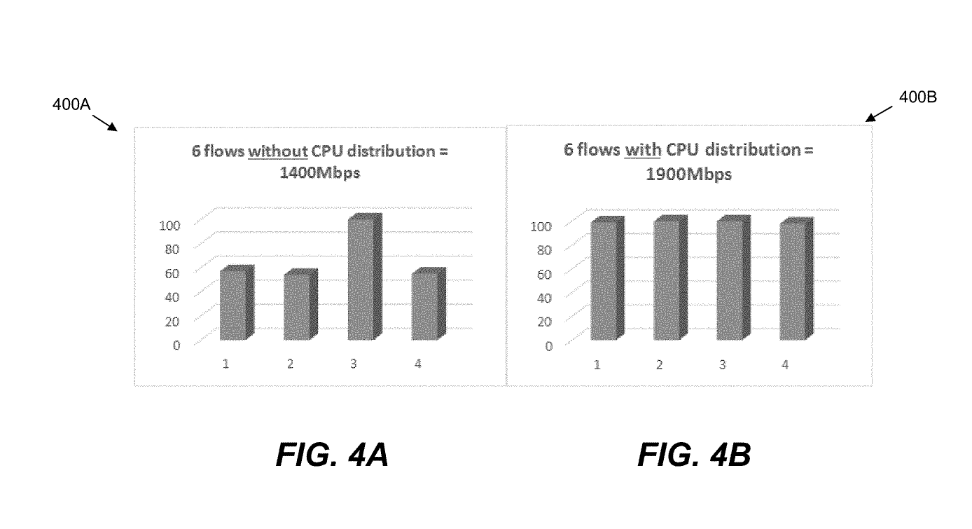

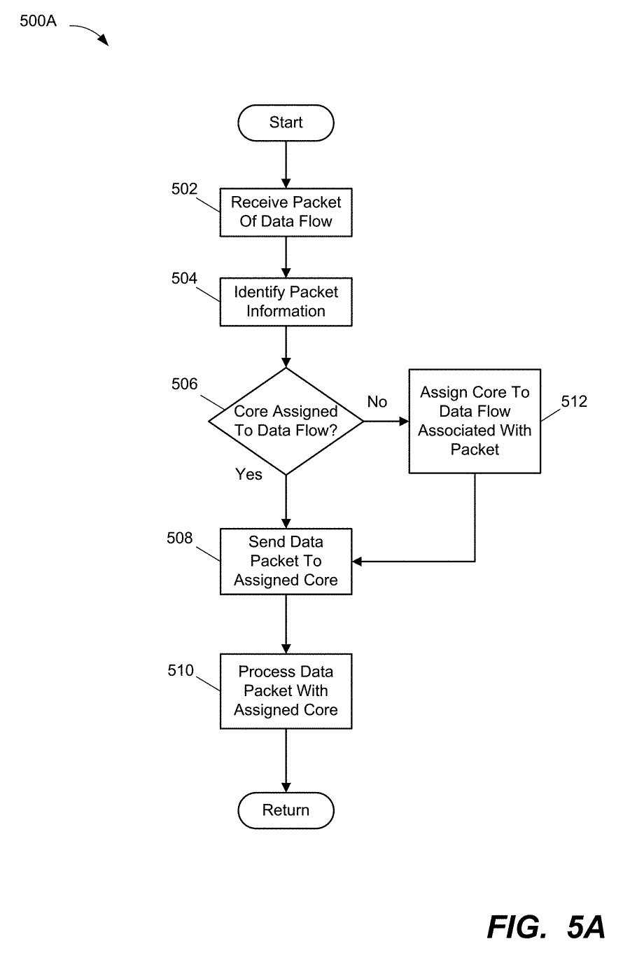

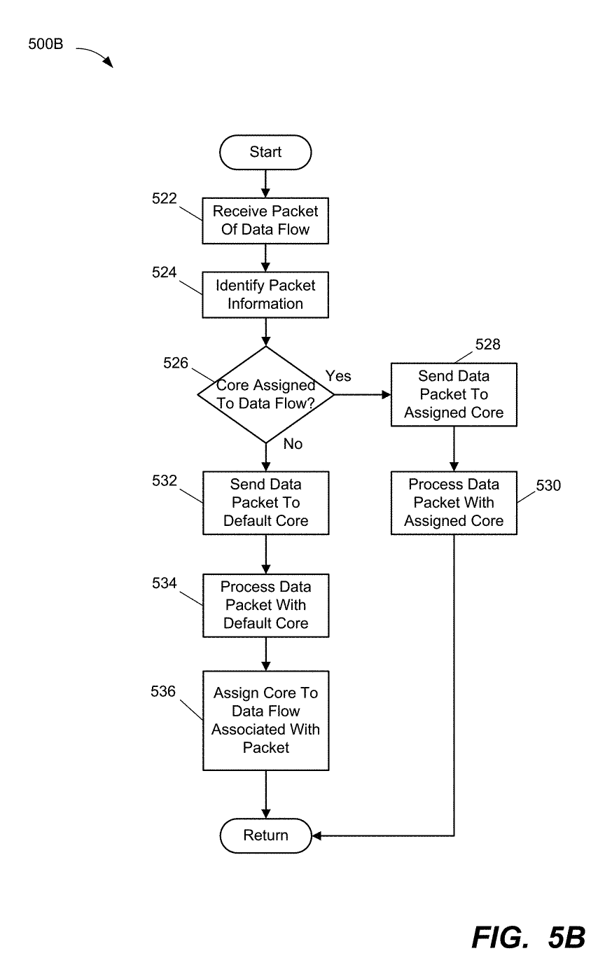

FIGS. 4A-4B are core utilization charts illustrating exemplary improved efficiencies from the system of FIG. 1 or FIG. 2 and/or the methods of FIGS. 5A-5B. Specifically, FIG. 4A illustrates the throughput of 6 data flows without managing the distribution of the data flows to the cores. FIG. 4B illustrates when the 6 data flows are assigned by a Classification Engine 122, 222 to avoid the per packet overhead of intra-core interrupts, and are assigned to balance the workflow, in accordance with an embodiment of the system of FIG. 1 or FIG. 2 and/or the methods of FIGS. 5A-5B. As illustrated in FIG. 4B the present systems and methods result in improved work load balancing among the cores, and a significantly higher total throughput.

FIG. 5A is a flowchart illustrating aspects of an exemplary method 500A for improved receive network traffic distribution for multi-core processor systems. Method 500A may be implemented by a device 102 illustrated in FIG. 1 and/or the components illustrated in FIG. 2. Method 500A begins in block 502 with the receipt of a data packet of a data flow. The data flow is part of Rx Network Traffic and may be one of multiple different data flows. The packet is received in block 502 at a Classification Subsystem 120, and in particular by a Classification Engine 122/222 of FIG. 1 or 2 coupled to an interface, such as MAC 223 illustrated in FIG. 2. The Classification Engine 122/222 may be a hardware component.

In block 504 packet information is identified for the received data packet. Such packet information may identify the data flow of which the packet is a part and/or may identify the type of network traffic contained in the packet/data flow (such as voice traffic, multicast traffic, etc.). In an embodiment, the packet information may include 5-tuple information discussed above for the packet. The identification of block 504 may comprise the Classification Engine 122/222 determining or identifying the packet information from the received data packet. In other embodiments, the identification of block 504 may comprise the Classification Engine 122/222 receiving the packet information from another component, such as from Receive Packet Engine 224.

Method 500A continues to block 506 where a determination is made whether any core is assigned to the data flow of the received packet. The determination in block 506 is made by Classification Engine 122/222 and may comprise the Classification Engine 122/222 looking up a flow entry in Data Flow Entry Table 116/126 (FIG. 1) or 216/226 (FIG. 2) for the data flow. In an embodiment one of Data Flow Entry Tables 116/126 or 216/226 contains a plurality of flow entries, with each flow entry containing information mapping or associating a data flow to a core of a multi-core processor, such as one of the cores 106a-106n (FIG. 1) or 206a-206n (FIG. 2) of the Processor Subsystem 104. Each flow entry contains information about the assigned core, such as a core number or other identifier, to allow a determination of which core is assigned to a particular data flow.

For some embodiments, there may be only one Data Flow Entry Table which may be located in the Memory Subsystem 112 or the Classification Subsystem 120 as desired. In other embodiments, there may be a first Data Flow Entry Table 126/226 that is part of the Classification Subsystem 120 (and in some implementations contained within Classification Engine 122/222) and a second Data Flow Entry Table 116/216 that is located in the Memory Subsystem 112. In some implementations of these embodiments, block 506 may comprise the Classification Engine 122/222 checking the first Data Flow Entry Table 116/216 and second Data Flow Entry Table 116/216 sequentially for a flow entry associated with a data flow. In other implementations, block 506 may comprise the Classification Engine 122/222 checking the first Data Flow Entry Table 116/216 or second Data Flow Entry Table 116/216 according to some other criteria, rule, or policy, such as choosing the Data Flow Entry Table to search based on the type of data flow (e.g. voice traffic, multicast traffic, etc.) or mechanisms like hash based Data Flow Entry Table lookups.

If it is determined in block 506 that a core has been assigned to the data flow of which the packet is a part, method 500A continues to block 508 and forwards or sends the data packet to the assigned core. Forwarding the data packet to the assigned core of block 508 comprises the Classification Subsystem 120 placing the data packet into one of a plurality of Queues 114/214, where each of the Queues 114/214 is dedicated or associated with one of the cores, such as cores 106a-106n of FIG. 1 or 206a-206n of FIG. 2. In an embodiment, the Classification Engine 122/222 is in communication with the Queues 114/214 and block 508 comprises the Classification Engine 122/222 causing the data packet to be placed into the Queue 114/214 associated with the core of the Processor Subsystem 104 determined to be assigned to the packet (block 506).

Method 500A continues to block 510 where the data packet is processed by the assigned core. In an embodiment, block 510 may comprise an Rx Thread 207a-207n of the assigned core 206a-206n retrieving the data packet from the Queue 214a-214n associated with the core 206a-206n and causing the data packet to be processed by the assigned core 206a-206n. In some embodiments, the data packet may then be forwarded to another device, such as a Recipient Device 130 (see FIGS. 1 and 2) in communication with the Processor Subsystem 104. Method 500A then returns and will begin again for each subsequent data packet received by the Classification Subsystem 120.

Returning to block 506, if the determination is that no core has been assigned to the data flow of which the received packet is a part, a core is assigned to the data flow of the packet in block 512. The assignment of the core to a data flow in block 512 may be made in some embodiments by the Classification Engine 122/222 based on desired criteria, policies or rules. For example, by using two bits of a hash of 5-tuple information for the data packet as discussed above, the Classification Engine 122/222 may randomly assign each new data flow received to a core 106a-106n or 206a-206n of Processor Subsystem 104. The assignment of the core to the data flow in block 512 may further comprise the Classification Engine 122/222 creating or updating a flow entry for the data flow in a Data Flow Entry Table 116/126 (FIG. 1) or 216/226 (FIG. 2). As discussed above, the flow entry contains mapping or association information that allows the Classification Engine 122/222 to understand or determine which core has been assigned to the data flow when additional data packets for the data flow are received.

In other embodiments, the assignment of the core to a data flow in block 512 may in some embodiments be made by a Data Flow Assignment Module 110/210 of the Processor Subsystem 104. In such embodiments, the Data Flow Assignment Module 110/210 may assign the data flow to a core of the multi-core Processor Subsystem 104 based on desired criteria and/or current information about the status or workload of the cores. Such current information about the cores may comprise control information 209 (FIG. 2) that the Data Flow Assignment Module 210 receives or monitors from each of cores 206a-206n.

Control information 209 may include status information about the cores 206a-206n such as the work load of each of cores 206a-206n, what data flows are being handled by a particular core 206a-206n, or the amount/volume each core 206a-206n is handling. Based on this control information 209 and/or previously-defined criteria, rules, or policies, the Data Flow Assignment Module 210 may assign one of cores 206a-206n to a particular data flow of the Rx Network Traffic in block 512. The assignment of the core to the data flow in block 512 may further comprise the Data Flow Assignment Module 210 creating or updating a flow entry for the data flow in a Data Flow Entry Table 116/126 (FIG. 1) or 216/226 (FIG. 2). As discussed above, the flow entry contains mapping or association information that allows the Classification Engine 122/222 to understand or determine which core has been assigned to the data flow when additional data packets for the data flow are received.

In some embodiments, the assignment of a core to the data flow of which the packet is a part in block 512 may comprise a multi-step process performed by one or more components. For example, the assignment of a core to the dataflow may comprise the Classification Engine 122/222 initially assigning a core to the data flow based one or more criteria and creating a flow entry for the core/data flow assignment in a Data Flow Entry Table 116/216 or 216/226.

Block 512 may further comprise the Data Flow Assignment Module 110/210 subsequently assessing the core assignment and/or reassigning the data flow to a different core based on one or more criteria (which may be different from the criteria used to make the initial core assignment) and/or the control information 209 about the status of the cores, work load levels, number of data flows assigned to each core, etc. If the Data Flow Assignment Module 110/210 determines to reassign the data flow to a different core, the Data Flow Assignment Module 110/210 may update the flow entry for the data flow in the Data Flow Entry Table 116/216 or 216/226 to reflect the new core assigned to the data flow. In some embodiments, the Data Flow Assignment Module 110/210 may continually assess whether to reassign one or more data flows based on various criteria, policies or rules, and/or the control information 209.

Once a core is assigned to the date flow in block 512, method 500A continues to block 508 where the data packet is sent to the assigned core for processing as discussed above. It will be understood that with method 500A operating on a device such as device 102, the packets of various data flows are only processed by a single core, i.e. the core assigned to the data flow of which the packet is a part. In this manner, data packets may be forwarded to the appropriate core without the per packet overhead associated with processing or classifying a data packet on a first core (in a first clock cycle), and then transferring the data packet to the appropriate core for processing using intra-core interrupts (in a subsequent clock cycles).

FIG. 5B is a flowchart illustrating aspects of another embodiment of an exemplary method 500B for improved receive network traffic distribution for multi-core processor systems. Method 500B is similar to method 500A of FIG. 5A except with respect to the actions taken when the determination of the third block 526—the determination whether a core is assigned to a data flow similar to block 506 of method 500A above—is that no core has been assigned to the data flow of which the packet is a part. The other blocks 522 (receive a data packet of a data flow), 524 (identify packet information for the received data packet), 526 (determination whether a core is assigned to the data flow of the received packet), 528 (send data packet to the determined assigned core), and 530 (process data packet with the assigned core) are the same as the corresponding blocks 502-510 of method 500A discussed above for FIG. 5A. The discussion above of blocks 502-510 of FIG. 5A applies equally to blocks 522-530 of FIG. 5B and will not be repeated for FIG. 5B.

Returning to block 526 of FIG. 5B, if the determination is that no core has been assigned to the data flow of which the received packet is a part, method 500B continues to block 532 where the data packet is sent to a default core. In this embodiment, the Classification Subsystem 120 is configured to send any packets of data flows not assigned to any core to a default core of the Processor Subsystem 104, which may be any core or cores of the Processor Subsystem 104. In an embodiment, this determination of a default core in block 532 does not include creating a flow entry for the data flow in Data Flow Entry Table 116/216 or 126/225. In such embodiments, the flow entry for the data flow is not created until the data flow is actively assigned/re-assigned to a core.

The core designated as the default core may be predetermined and unchanging in some implementations. In other implementations, the core designated as the default core may change at different times and/or in response to various criteria or conditions. Once the default core is identified, sending the data packet to the default core in block 532 may be accomplished in any manner including those discussed above for block 508 of FIG. 5A—e.g. by the Classification Engine 122/222 causing the data packet to be placed into the Queue 114/214a-214n associated with the default core.

Method 500B then continues to block 534 where the data packet is processed with the default core. Block 534 is essentially the same as block 510 (process data packet with assigned core) described above for FIG. 5A and block 534 may similarly be accomplished as described above for block 510. In block 536 a core is assigned to the data flow associated with the received packet—i.e. the data flow may be re-assigned from the default core to a new core. Assigning a core the data flow in block 536 may be accomplished by the Classification Engine 122/222 or the Data Flow Assignment Module 110/210 (or a combination of both) in any manner discussed above for similar block 512 of FIG. 5A.

Additionally, the core assignment/reassignment from the default core in block 536 may be accomplished by one of the Classification Engine 122/222 of Data Flow Assignment Module 110/210 creating or updating a flow entry in Data Flow Entry Table 116/216 of Memory Subsystem 112 or Data Flow Entry Table 126/226 of Classification Engine 122/222. In some embodiments and circumstances, the applicable criteria or conditions may lead to a determination in block 536 that the data flow remains assigned to the default core, in which case a flow entry will be created for the data flow mapping or assigning the data flow to the default core by core number or identifier.

In other embodiments and/or circumstances, the applicable criteria or conditions may lead to a determination in block 536 that the data flow should be assigned to a different core than the default core. In this case, a flow entry will be created for the data flow mapping or assigning the data flow to the determined core, effectively re-assigning the data flow away from the default core. Once the data flow has been assigned to a core in block 536, method 500B then returns to await the receipt of the next data packet.

As will be understood, method 500B allows for the initial data packet(s) of a new data flow to be immediately processed—using a default core—before the new data flow is assigned to a particular core using the desired criteria, policies, rules and/or control information 209. However, any assignment of the data flow to a different core for processing is performed by one (or more) of Classification Engine 122/222 or Data Flow Assignment Module 110/210—i.e. such transfer in processing responsibilities is transparent to the cores, such as to 206a-206n of Processor Subsystem 104.

When the next data packet(s) for the data flow are received method 500B allows for the data packets to be directly sent to the new core for processing. In this manner, data packets may be forwarded via method 500B to the new/assigned core without the per packet overhead associated with processing or classifying a data packet on a default core (in a first clock cycle), and then transferring the data packet to the new/assigned core for processing using intra-core interrupts (in a subsequent clock cycles).

Referring to FIG. 6, this figure is a functional block diagram of an exemplary computing device 602 on which the system of FIG. 1, components of FIG. 2, and/or the methods of FIGS. 5A-5C may be implemented. The computing device 602 may be utilized as a home gateway as mentioned above, as a server, or as any other desired computing device. The exemplary operating environment for the system 600 includes a general-purpose computing device in the form of a conventional computer 602.

Generally, computing device 602 may include a multicore central processing unit (CPU) processing subsystem 104, which may be the Processor Subsystem 104 detailed above in FIGS. 1-2. The computing device 602 may further comprise system memory 112, and a system bus 105 (similar to Interconnect 105 of FIG. 1) that couples various system components including the system memory 112 to the Processor Subsystem 104. The system memory 112 or portions thereof may be included in, or may comprise the Memory Subsystem 112 detailed in FIGS. 1-2. Similarly, system bus 105 may be any of several types of bus structures including a memory bus or memory controller, a peripheral bus, and a local bus using any of a variety of bus architectures, and may be the Interconnect 105 described above in connection with FIG. 1.

In the illustrated embodiment, the system memory 112 includes a read-only memory (ROM) 324 and a random access memory (RAM) 325. A basic input/output system (BIOS) 326, containing the basic routines that help to transfer information between elements within computing device 602, such as during start-up, is stored in ROM 324.

The computing device 602 may include a hard disk drive 327A for reading from and writing to a hard disk, not shown, a supplemental storage drive for reading from or writing to a removable supplemental storage 329 (like flash memory and/or a USB drive) and an optical disk drive 330 for reading from or writing to a removable optical disk 331 such as a CD-ROM or other optical media. One or more of these storage drives may be part of the Memory Subsystem 112 of FIGS. 1-2. Hard disk drive 327A, supplemental storage drive 328, and optical disk drive 330 are connected to system bus 105 by a hard disk drive interface 332, a supplemental storage drive interface 333, and an optical disk drive interface 334, respectively.

Although the exemplary environment described herein employs hard disk 327A, supplemental storage 329, and removable optical disk 331, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment without departing from the scope of the disclosure. Such uses of other forms of computer readable media besides the hardware illustrated will be used in internet connected devices.

The drives and their associated computer readable media illustrated in FIG. 6 provide nonvolatile storage of computer-executable instructions, data structures, program modules, and other data for computing device 602 and any other computing devices in communication with computing device 602, such as Recipient Device(s) 130 discussed above for FIGS. 1-2. A number of program modules may be stored on hard disk 327, supplemental storage 329, optical disk 331, ROM 324, or RAM 325, including, but not limited to, an operating system 108, one or more Queues 114 (see FIGS. 1-2), a Data Flow Entry Table 116 (see FIGS. 1-2), and the Data Flow Assignment Module 110 (see FIGS. 1-2).

Program modules include routines, sub-routines, programs, objects, components, data structures, etc., which perform particular tasks or implement particular abstract data types. Aspects of the present invention may be implemented in the form of downloadable software that includes module 110. Alternatively, module 110 may be implemented as hardware or firmware, or any combination thereof.

A user may enter commands and information into computing device 602 if desired through input devices, such as a keyboard 340 or a pointing device 342. Pointing devices may include a mouse, a trackball, and an electronic pen that can be used in conjunction with an electronic tablet. Other input devices (not shown) may include a microphone, joystick, game pad, satellite dish, scanner, or the like. These and other input devices are often connected to processing subsystem 104 through a serial port interface 346 that is coupled to the system bus 105, but may be connected by other interfaces, such as a parallel port, game port, a universal serial bus (USB), or the like.

A display 347 may also be connected to system bus 105 via an interface, such as a video adapter 348. Although optional, if a display 347 is implemented for the computing device 602, the display 347 can comprise any type of display devices such as a liquid crystal display (LCD), a plasma display, an organic light-emitting diode (OLED) display, and a cathode ray tube (CRT) display.

Similarly, an optional camera 375 may also be connected to system bus 105 via an interface, such as an adapter 370. The camera 375 can comprise a video camera such as a webcam. The camera 375 can be a CCD (charge-coupled device) camera or a CMOS (complementary metal-oxide-semiconductor) camera. In addition to the monitor 347 and camera 375, the computing device 602, may include other peripheral output devices (not shown) in some embodiments, such as speakers and printers (not illustrated).

The computing device 602 may operate in a networked environment using logical connections to one or more remote computers. A remote computer (not illustrated) may be another personal computer, a server, a mobile phone, a router, a network PC, a peer device, or other common network node. The logical connections with all such remote computers are depicted in the Figure with the arrows labelled Rx Network Traffic as discussed above (see FIGS. 1-2). Such connections with other remote computers may include a local area network (LAN) and a wide area network (WAN). Such networking environments are commonplace in offices, enterprise-wide computer networks, intranets, and the Internet.

The computing device 602 may receive Rx Network Traffic, including from a LAN, through a network interface or adapter which may be part of the Classification Subsystem 120 illustrated in FIG. 6. Details of various embodiments of the Classification Subsystem are described above for FIGS. 1-2. Additionally, the computing device 602 may receive Rx Network Traffic through a modem 354 as illustrated.

For example, when used in a WAN networking environment, the computing device 602 may include a modem 354 or other means for establishing communications over WAN, such as the Internet. Modem 354, which may be internal or external, is connected to system bus 105 via serial port interface 346, and data packets received by the modem 354 are also first routed through the Classification Subsystem 120 as discussed above. It will be appreciated that the network connections shown are exemplary and other means of establishing a communications link between the computers 300A-300B may be used.

Moreover, those skilled in the art will appreciate that the present invention may be implemented in other computer system configurations, including hand-held devices, multiprocessor systems, microprocessor based or programmable consumer electronics, network personal computers, minicomputers, mainframe computers, and the like as discussed above. The invention may also be practiced in distributed computing environments, where tasks are performed by remote processing devices that are linked through a communications network. In a distributed computing environment, program modules may be located in both local and remote memory storage devices.

In a particular aspect, one or more of the method steps described herein (such as illustrated in connection with FIGS. 5A-5B) may be stored in the memory 112 as computer program instructions. These instructions may be executed by multi-core central processing subsystem 104, an analog signal processor, or another processor, to perform the methods 500A and/or 500B described herein. Further, the processing subsystem 104, the memory 112, the instructions stored therein, or a combination thereof may serve as a means for performing one or more of the method steps described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the scope of the disclosure, as defined by the following claims.

What is claimed is:

1. A method for improved received network traffic distribution in a multi-core computing device, the method comprising:
receiving at a hardware classification engine of the computing device a data packet, the data packet comprising a portion of a received network traffic data flow;
identifying packet information from the data packet;
determining with the classification engine, based in part on the packet information, whether a core of a multi-core processor subsystem is assigned to the data flow of which the packet is a part;
responsive to the determination that a core is not assigned to the data flow, assigning a first core of the multi-core processor to the data flow; and
sending the data packet to the first core for processing.

2. The method of claim 1, wherein determining with the classification engine whether a core of the multi-core processor subsystem is assigned to the data flow further comprises performing a look up in a data flow entry table.

3. The method of claim 2, wherein the data flow entry table is contained within a memory subsystem, the memory subsystem in communication with the classification engine and the processor subsystem.

4. The method of claim 1, wherein assigning the first core of the multi-core processor to the data flow responsive to the determination that a core is not assigned to the data flow further comprises:
determining to process the data flow with the first core based on one of a hash of the packet information or a fixed mapping of the data flow to the first core.

5. The method of claim 1, wherein assigning the first core of the multi-core processor to the data flow further comprises:
determining to process the data flow with the first core based on a predetermined criteria.

6. The method of claim 5, wherein the hardware classification engine performs the determination to process the data flow with the first core based on the predetermined criteria.

7. The method of claim 5, wherein:
the criteria comprises one of a work load level of one or more of the cores of the processor subsystem, a priority level of the data flow, or a type of data in the data flow, and
a data flow assignment module of the processor subsystem performs the determination to process the data flow with the first core based on the predetermined criteria.

8. The method of claim 5, wherein assigning the first core of the multi-core processor to the data flow further comprises:
creating an entry for the data flow in the data flow entry table mapping an identifier for the first core to the data flow.

9. The method of claim 1, wherein sending the data packet to the first core for processing comprises:
placing the data packet in a queue of the memory subsystem, the queue associated with the first core.

10. The method of claim 9, further comprising:
processing the data packet at the first core with a receive thread (Rx thread) of the first core.

11. The method of claim 1, wherein the computing device comprises a network gateway.

12. A computer system for providing efficient received network traffic distribution in a computing device, the system comprising:
a memory subsystem;
a processor subsystem in communication with the memory subsystem, the processor subsystem comprising a plurality of cores; and
a classification subsystem in communication with the memory subsystem and the processor subsystem, the classification subsystem including a hardware classification engine configured to:
receive a data packet comprising a portion of a received network traffic data flow;
identify packet information from the data packet;
determine, based in part on the packet information, whether any of the plurality of cores of the processor subsystem is assigned to the received data flow;
responsive to the determination that none of the plurality of cores is assigned to the data flow, assign a first core of the plurality of cores to the data flow; and
send the data packet to the first core.

13. The system of claim 12, wherein the hardware classification engine is further configured to determine whether any of the plurality of cores of the processor subsystem is assigned to the received data flow by looking up in a data flow entry table.

14. The system of claim 13, wherein the data flow entry table is contained within the memory subsystem.

15. The system of claim 12, wherein the hardware classification engine is configured to
assign the first core of the plurality of cores to the data flow, responsive to the determination that none of the plurality of cores is assigned to the data flow, by determining to process the data flow with the first core based one of a hash of the packet information or
a fixed mapping of the data flow to the first core.

16. The system of claim 12, wherein the hardware classification engine is configured to
assign the first core of the plurality of cores to the data flow by determining to process the data flow with the first core based on a predetermined criteria.

17. The system of claim 16, wherein the criteria comprises one of a work load level of one or more of the cores of the processor subsystem, a priority level of the data flow, or a type of data in the data flow.

18. The system of claim 16, wherein the processor subsystem further comprises a data flow assignment module configured to:
assign a second core of the plurality of cores to the data flow based on the predetermined criteria, where the predetermined criteria includes at least a work load level of one or more of the plurality of cores.

19. The system of claim 16, wherein assigning the first core of the multi-core processor to the data flow further comprises:
creating an entry for the data flow in the data flow entry table mapping an identifier for the first core to the data flow.

20. The system of claim 12, wherein:
the memory subsystem further comprises a plurality of queues, each of the plurality of queues in communication with a different one of the plurality of cores, and
the hardware classification engine is configured to send the data packet to the first core by placing the data packet in a first queue in communication with the first core.

21. The system of claim 20, wherein the first core is configured to:
process the data packet with a receive thread (Rx thread) of the first core.

22. The system of claim 12, wherein the computing device comprises a network gateway.

23. A computer program product comprising a non-transitory computer usable medium having a computer readable program code embodied therein, said computer readable program code adapted to be executed to implement a method for improved received network traffic distribution in a multi-core computing device, the method comprising:
receiving at a hardware classification engine of the computing device a data packet, the data packet comprising a portion of a received network traffic data flow;
identifying packet information from the data packet;
determining with the classification engine, based in part on the packet information, whether a core of a multi-core processor subsystem is assigned to the data flow of which the packet is a part;
responsive to the determination that a core is not assigned to the data flow, assigning a first core of the multi-core processor to the data flow; and
sending the data packet to the first core for processing.

24. The computer program product of claim 23, wherein determining with the classification engine whether a core of the multi-core processor subsystem is assigned to the data flow further comprises performing a look up in a data flow entry table.

25. The computer program product of claim 24, wherein the data flow entry table is contained within a memory subsystem, the memory subsystem in communication with the classification engine and the processor subsystem.

26. The computer program product of claim 23, wherein assigning the first core of the multi-core processor to the data flow responsive to the determination that a core is not assigned to the data flow further comprises:
determining to process the data flow with the first core based on one of a hash of the packet information or a fixed mapping of the data flow to the first core.

27. A computer system for providing efficient received network traffic distribution in a computing device, the system comprising:
means for receiving at a hardware classification engine of the computing device a data packet, the data packet comprising a portion of a received network traffic data flow;
means for identifying packet information from the data packet;
means for determining with the classification engine, based in part on the packet information, whether a core of a multi-core processor subsystem is assigned to the data flow of which the packet is a part;
means responsive to the determination that a core is not assigned to the data flow for assigning a first core of the multi-core processor to the data flow; and
means for sending the data packet to the first core for processing.

28. The system of claim 27, wherein the means for determining with the classification engine whether a core of the multi-core processor subsystem is assigned to the data flow further comprises means for performing a look up in a data flow entry table.

29. The system of claim 28, wherein the data flow entry table is contained within a memory subsystem, the memory subsystem in communication with the classification engine and the processor subsystem.

30. The system of claim 27, wherein the means for assigning the first core of the multi-core processor to the data flow further comprises:
means for determining to process the data flow with the first core based on a hash of the packet information.
